(19) United States
(12) Patent Application Publication
(10) Pub. No.: US 2014/0145530 A1
(43) Pub. Date: May 29, 2014

(54) USE OF PEK AND PEKEKK ON MAGNET WIRE

(71) Applicant: GE OIL & GAS ESP, INC., Oklahoma City, OK (US)

(72) Inventors: Brian Paul Reeves, Edmond, OK (US); Edward John Flett, Oklahoma City, OK (US); Jerome Dowd, Oklahoma City, OK (US)

(73) Assignee: GE OIL & GAS ESP, INC., Oklahoma City, OK (US)

(21) Appl. No.: 13/687,915

(22) Filed: Nov. 28, 2012

(51) Int. Cl. H02K 3/44; H02K 3/38; H02K 3/30

(52) U.S. Cl. CPC H02K 3/44; H02K 3/30; H02K 3/38
USPC 310/71; 310/208; 310/87

(57) ABSTRACT

An electric motor assembly configured for use in a downhole pumping system includes a plurality of stator coils. Each of the plurality of stator coils includes magnet wire that has an insulator surrounding a conductor. In preferred embodiments, the insulator is manufactured from a material selected from the group consisting of polyether ketone and polyether ketone ether ketone ketone.

### FIELD OF THE INVENTION

This invention relates generally to the field of electric motors, and more particularly, but not by way of limitation, to improved magnet wire for use in high-temperature downhole pumping applications.

### BACKGROUND

Electrodynamic systems such as electric motors, generators, and alternators typically include a stator and a rotor. The stator typically has a metallic core with electrically insulated wire winding through the metallic core to form the stator coil. When current is alternately passed through a series of coils, magnetic flux fields are formed, which cause the rotor to rotate in accordance with electromagnetic physics. To wind the stator coil, the wire is first threaded through the stator core in one direction, and then turned and threaded back through the stator in the opposite direction until the entire stator coil is wound. Each time the wire is turned to run back through the stator, an end turn is produced. A typical motor will have many such end turns upon completion.

Electrical submersible pumping systems include specialized electric motors that are used to power one or more high performance pump assemblies. The motor is typically an oil-filled, high capacity electric motor that can vary in length from a few feet to nearly fifty feet, and may be rated up to hundreds of horsepower. The electrical submersible pumping systems are often subjected to high-temperature, corrosive environments. Each component within the electrical submersible pump must be designed and manufactured to withstand these hostile conditions.

In the past, motor manufacturers have used various insulating materials on the magnet wire used to wind the stator. Commonly used insulation includes polyether ether ketone (PEEK) thermoplastics. Insulating the conductor in the magnet wire prevents the electrical circuit from shorting or otherwise prematurely failing. The insulating material is typically extruded or sprayed onto the underlying copper conductor. In recent years, manufacturers have used insulating materials that are resistant to heat, mechanical wear and chemical exposure.

Although widely accepted, current insulation materials may be inadequate for certain high-temperature downhole applications. In particular, motors employed in downhole applications where modern steam-assisted gravity drainage (SAGD) recovery methods are employed, the motor may be subjected to elevated temperatures. There is, therefore, a need for an improved magnet wire that exhibits enhanced resistance to heat, corrosive chemicals, mechanical wear and other aggravating factors. It is to this and other deficiencies in the prior art that the present invention is directed.

### SUMMARY OF THE INVENTION

In a preferred embodiment, the present invention provides an electric motor assembly configured for use in a downhole pumping system. The motor assembly includes a plurality of stator coils and each of the plurality of stator coils includes magnet wire that has an insulator surrounding a conductor. In preferred embodiments, the insulator is manufactured from a material selected from the group consisting of polyether ketone and polyether ketone ether ketone ketone.

### BRIEF DESCRIPTION OF THE DRAWINGS

FIG. 1 is a back view of a downhole pumping system constructed in accordance with a presently preferred embodiment.

FIG. 2 is a partial cross-sectional view of the motor of the pumping system of FIG. 1.

FIG. 3 is a close-up partial cut-away view of a piece of magnet wire from the motor of FIG. 2 which has extruded insulation.

FIG. 4 is a close-up partial cut-away view of a piece of magnet wire from the motor of FIG. 2 which has tape wrapped insulation.

FIG. 5 is a perspective view of a round power cable constructed in accordance with a first preferred embodiment.

FIG. 6 is a perspective view of a flat power cable constructed in accordance with a second preferred embodiment.

### DETAILED DESCRIPTION OF THE PREFERRED EMBODIMENTS

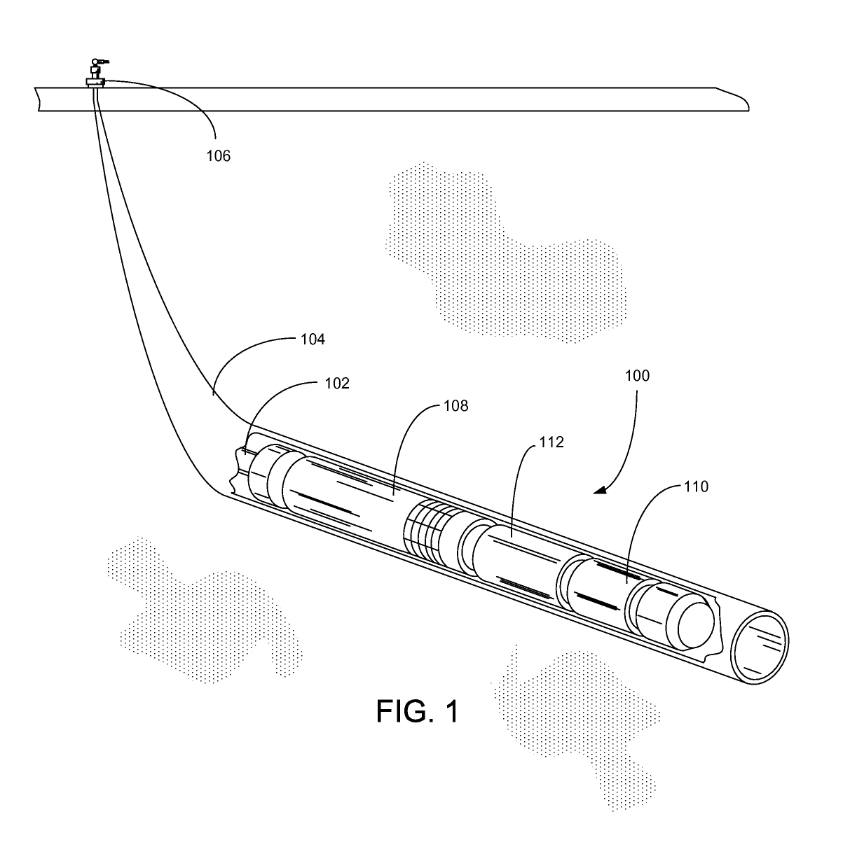

In accordance with a preferred embodiment of the present invention, FIG. 1 shows a front perspective view of a downhole pumping system 100 attached to production tubing 102. The downhole pumping system 100 and production tubing 102 are disposed in a wellbore 104, which is drilled for the production of a fluid such as water or petroleum. The downhole pumping system 100 is shown in a non-vertical well. This type of well is often referred to as a “horizontal” well. Although the downhole pumping system 100 is depicted in a horizontal well, it will be appreciated that the downhole pumping system 100 can also be used in vertical wells.

As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move other fluids. It will also be understood that, although each of the components of the pumping system 100 are primarily disclosed in a submersible application, some or all of these components can also be used in surface pumping operations.

The pumping system 100 preferably includes some combination of a pump assembly 108, a motor assembly 110 and a seal section 112. In a preferred embodiment, the motor assembly 110 is an electrical motor that receives its power from a surface-based supply. The motor assembly 110 converts the electrical energy into mechanical energy, which is transmitted to the pump assembly 108 by one or more shafts. The pump assembly 108 then transfers a portion of this mechanical energy to fluids within the wellbore, causing the wellbore fluids to move through the production tubing to the surface. In a particularly preferred embodiment, the pump assembly 108 is a turbomachine that uses one or more impellers and diffusers to convert mechanical energy into pressure head. In an alternative embodiment, the pump assembly 108 is a progressive cavity (PC) or positive displacement pump that moves wellbore fluids with one or more screws or pistons.

The seal section 112 shields the motor assembly 110 from mechanical thrust produced by the pump assembly 108. The seal section 112 is also preferably configured to prevent the introduction of contaminants from the wellbore 104 into the motor assembly 110. Although only one pump assembly 108, seal section 112 and motor assembly 110 are shown, it will be understood that the downhole pumping system 100 could include additional pumps assemblies 108, seals sections 112 or motor assemblies 110.

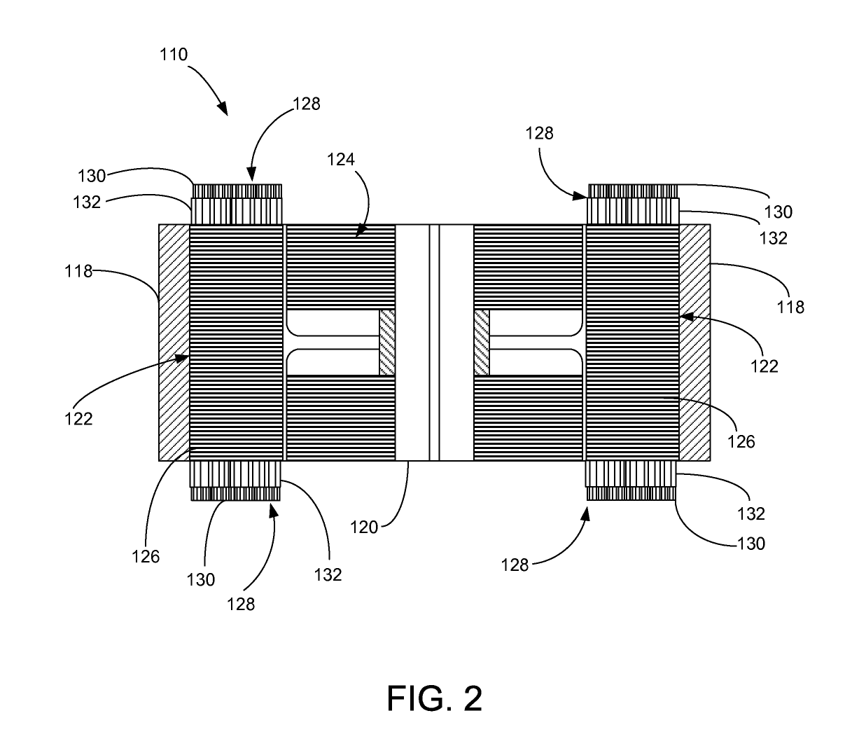

Referring now to FIG. 2, shown therein is an elevational partial cross-section view of the motor assembly 110. The motor assembly 110 includes a motor housing 118, a shaft 120, a stator assembly 122, and a rotor 124. The motor housing 118 encompasses and protects the internal portions of the motor assembly 110 and is preferably sealed to reduce the entry of wellbore fluids into the motor assembly 110. Adjacent the interior surface of the motor housing 118 is the stationary stator assembly 122 that remains fixed relative the motor housing 118. The stator assembly 122 surrounds the interior rotor 124, and includes stator coils (not shown) and a stator core 126. The stator core 126 is formed by stacking and pressing a number of thin laminates to create an effectively solid stator core 126.

The stator core 126 includes multiple stator slots. Each stator coil is preferably created by winding a magnet wire 128 back and forth though slots in the stator core 126. Each time the magnet wire 128 is turned 180° to be threaded back through an opposing slot, an end turn (not shown in FIG. 2) is produced, which extends beyond the length of the stator core 126. The magnet wire 128 includes a conductor 130 and an insulator 132. It will be noted that FIG. 2 provides an illustration of multiple passes of the magnet wires 128. The coils of magnet wire 128 are terminated and connected to a power source using one of several wiring configurations known in the art, such as a wye or delta configurations.

Electricity flowing through the stator 122 according to different commutation states creates a rotating magnetic field, which acts upon rotor bars (not shown) and causes the rotor 124 to rotate. This, in turn, rotates the shaft 120. The phases in a motor assembly 110 are created by sequentially energizing adjacent stator coils, thus creating the rotating magnetic field. Motors can be designed to have different numbers of phases and different numbers of poles. In a preferred embodiment, an ESP motor is a two pole, three phase motor in which each phase is offset by 120°. It will be understood, however, that the method of the preferred embodiment will find utility in motors with different structural and functional configurations or characteristics.

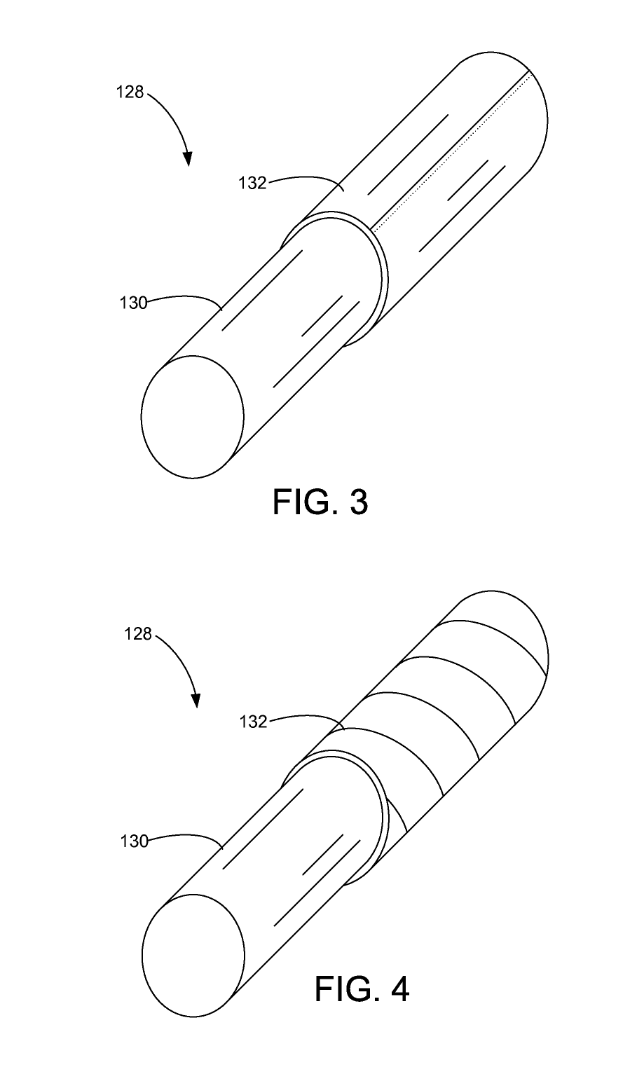

Turning to FIGS. 3 and 4, shown therein is a perspective view of a short section of the magnet wire 128. The conductor 130 is preferably constructed from fully annealed, electrolytically refined copper. In an alternative embodiment, the conductor 130 is manufactured from aluminum. Although solid-core conductors 130 are presently preferred, the present invention also contemplates the use of braided or twisted conductors 130. It will be noted that the ratio of the size of the conductor 130 to the insulator 132 is for illustrative purposes only and the thickness of the insulator 132 relative to the diameter of the conductor 130 can be varied depending on the particular application.

In a first preferred embodiment, the insulator 132 is a polyether ketone (PEK) thermoplastic. Particularly preferred PEK thermoplastics have a melting point of above about 373° C. Suitable PEK insulation is available from Victrex Manufacturing Limited, Rotherham, South Yorkshire, United Kingdom, under the Victrex-HT line of products. Particularly preferred products include Victrex® PEEK-HT™ G22 brand PEK thermoplastic.

In a second preferred embodiment, the insulator 132 is a polyetherketoneehterketonekteone (PEKEKK) thermoplastic having a melting point of above about 387° C. Suitable PEKEKK insulation is available from Victrex Manufacturing Limited, Rotherham, South Yorkshire, United Kingdom, under the Victrex-ST line of products. Particularly preferred products include Victrex® ST™ STG45 brand PEKEKK thermoplastic.

The insulator 132 is preferably extruded onto the conductor 130 to provide a seamless layer of insulation having a consistent thickness. The thickness of the insulator 132 can be adjusted during manufacturing of the magnet wire 128 to meet the requirements of particular applications. Although a single form of insulation has traditionally been used, it is contemplated as within the scope of the present invention to magnet wire 128 having different insulators 132 on different portions of the conductor 130. For example, it may be desirable to use higher-temperature insulator 132 on portions of the magnet wire 128 that are exposed to higher temperatures within the motor assembly 110. The use of PEK and PEKEKK insulators 132 significantly increases the thermal resistance of the magnet wire 128 over the prior art use of traditional polyarylketones, such as polyether ether ketone (PEEK).

In alternate embodiment, one or more fillers are added to the PEK or PEKEKK to form a composite insulator 132. Suitable fillers include glass fiber, talc and other minerals. In yet an additional embodiment, glass fibers can be used to create a separate glass fiber cloth layer that is distinct from the glass fiber filler used in the composite insulator 132. Furthermore, it may be desirable to prepare a magnet wire 128 that includes multiple layers of insulator 132. In a first preferred multilayer embodiment, the magnet wire includes an inner layer constructed from a first insulator selected from the group consisting of PEK, PEKEKK, composite insulators, glass fiber cloth, and polyimide films and an outer layer constructed from a second insulator selected from the group consisting of PEK, PEKEKK, composite insulators, glass fiber cloth and polyimide films. In particularly preferred embodiments, the magnet wire 128 includes an outer insulation layer constructed from PEK or PEKEKK.

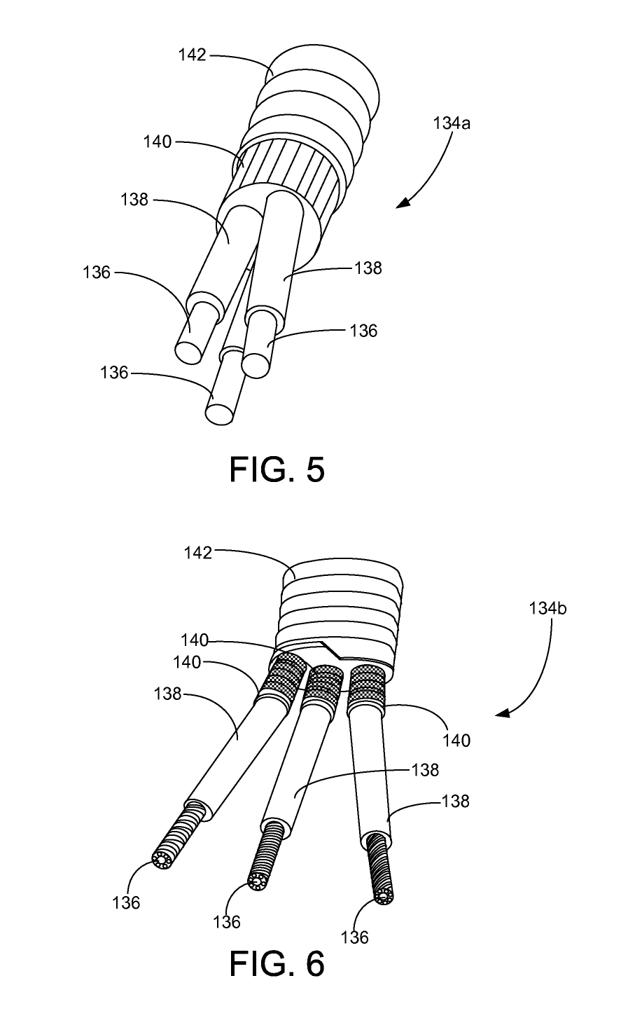

Turning to FIGS. 5 and 6, shown therein are perspective views of a round power cable 134a and a flat power cable 134b, respectively. It will be understood that the geometric configuration of the power cable 134 can be selected on an application specific basis. Generally, flat power cables 134b, as shown in FIG. 6, are preferred in applications where there is a limited amount of space around the pumping system 100 in the wellbore 104. As used herein, the term “power cable 134” collectively refers to the round power cable 134a and the flat power cable 134b. In the presently preferred embodiment, the power cable 134 includes power cable conductors 136, power cable insulators 138, a jacket 140 and external armor 142. The jacket 140 is protected from external contact by the armor 142. In the preferred embodiment, the armor is manufactured from galvanized steel, stainless steel, Monel or other suitable metal or composite. The armor 142 can be configured in flat and round profiles in accordance with the flat or round power cable configuration.

The power cable conductors 136 are preferably manufactured from copper wire or other suitable metal. The power cable conductors 136 can include a solid core (as shown in FIG. 2), a stranded core or a stranded exterior surrounding a solid core (as shown in FIG. 3). The power cable conductors 136 can also be coated with one or more layers of tin, nickel, silver, polyimide film or other suitable material. It will be understood that the size, design and composition of the power cable conductors 136 can vary depending on the requirements of the particular downhole application.

In a first preferred embodiment, the power cable insulators 138 preferably include at least one layer of a polyether ketone (PEK) thermoplastic having a melting point of above about 373° C. Suitable PEK insulation is available from Victrex Manufacturing Limited, Rotherham, South Yorkshire, United Kingdom, under the Victrex-HT line of products. Particularly preferred products include Victrex® PEEK-HT™ G22 brand PEK thermoplastic. In a second preferred embodiment, the power cable insulators 138 include at least one layer of a polyetherketoneehterketonekteone (PEKEKK) thermoplastic having a melting point of above about 387° C. Suitable PEKEKK insulation is available from Victrex Manufacturing Limited, Rotherham, South Yorkshire, United Kingdom, under the Victrex-ST line of products. Particularly preferred products include Victrex® ST™ G45 brand PEKEKK thermoplastic.

It may be desirable to prepare a power cable 134 that includes multiple layers of power cable insulator 138 around the power cable conductor 136. In a first preferred multilayer embodiment, the magnet wire includes an inner layer constructed from a first insulator selected from the group consisting of PEK, PEKEKK, glass fiber filler and polyimide films and an outer layer constructed from a second insulator selected from the group consisting of PEK, PEKEKK, glass fiber cloth and polyimide films. In particularly preferred embodiments, the magnet wire 128 includes an outer insulation layer constructed from PEK or PEKEKK.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. An electric motor assembly configured for use in a downhole pumping system, wherein the motor assembly comprises a plurality of stator coils, and wherein each of the plurality of stator coils comprises magnet wire having an insulator surrounding a conductor, wherein the insulator is manufactured from a material selected from the group consisting of polyether ketone and polyether ketone ether ketone ketone.

2. The electric motor assembly of claim 1, wherein the insulator is manufactured from polyether ketone.

3. The electric motor assembly of claim 1, wherein the insulator is manufactured from polyether ketone ether ketone ketone.

4. The electric motor assembly of claim 1, wherein the magnet wire further comprises:
a first insulator material selected from the group consisting of polyether ketone and polyether ketone ether ketone ketone; and
a second insulator material selected from the group consisting of polyether ketone, polyether ether ketone, polyimide and polyether ketone ether ketone ketone, wherein the second insulator material is different than the first insulator material.

5. The electric motor assembly of claim 4, wherein the first insulator material and second insulator material are used to surround different areas of the conductor.

6. The electric motor assembly of claim 4, wherein the first insulator material surrounds the conductor and the second insulator material surrounds the first insulator material.

7. The electric motor assembly of claim 4, wherein the second insulator material surrounds the conductor and the first insulator material surrounds the second insulator material.

8. The electric motor assembly of claim 4, further comprising an intermediate glass filled layer between the first insulator material and second insulator material.

9. The electric motor assembly of claim 4, wherein at least one of the first insulator material and second insulator materials includes a filler selected from the group consisting of glass fiber and talc.

10. An electrical submersible pumping system configured for operation in high-temperature applications, the electrical submersible pumping system comprising:
a pump assembly;
a motor assembly connected to pump assembly, wherein the motor assembly comprises a plurality of stator coils, and wherein each of the plurality of stator coils comprises magnet wire having an insulator surrounding a conductor, wherein the insulator is manufactured from a material selected from the group consisting of polyether ketone and polyether ketone ether ketone ketone.

11. The electrical submersible pumping system of claim 10, wherein the insulator is manufactured from polyether ketone.

12. The electrical submersible pumping system of claim 10, wherein the insulator is manufactured from polyether ketone ether ketone ketone.

13. The electrical submersible pumping system of claim 10, wherein the magnet wire further comprises:
a first insulator material selected from the group consisting of polyether ketone and polyether ketone ether ketone ketone; and
a second insulator material selected from the group consisting of polyether ketone, polyether ether ketone, polyimide, and polyether ketone ether ketone ketone, wherein the second insulator material is different than the first insulator material.

14. The electrical submersible pumping system of claim 13, wherein the first insulator material and second insulator material are used to surround different areas of the conductor.

15. The electrical submersible pumping system of claim 13, wherein the first insulator material surrounds the conductor and the second insulator material surrounds the first insulator material.

16. The electric submersible pumping system of claim 13, wherein the second insulator material surrounds the conductor and the first insulator material surrounds the second insulator material.

17. The electrical submersible pumping system of claim 13, further comprising an intermediate glass filled layer between the first insulator material and second insulator material.

18. The electrical submersible pumping system of claim 13, wherein at least one of the first insulator material and second insulator materials includes a filler selected from the group consisting of glass fiber and talc.

19. An electrical submersible pumping system configured for operation in high-temperature applications, the electrical submersible pumping system comprising:
a pump assembly;
a motor assembly connected to pump assembly; and
a power cable connected to the motor assembly, wherein the power cable comprises:
a power cable conductor; and
a power cable insulator, wherein the power cable insulator is manufactured from a material selected from the group consisting of polyether ketone and polyether ketone ether ketone ketone.

20. The electrical submersible pumping system of claim 19, wherein the power cable insulator is manufactured from polyether ketone.

21. The electrical submersible pumping system of claim 19, wherein the power cable insulator is manufactured from polyether ketone ether ketone ketone.

22. The electrical submersible pumping system of claim 19, wherein the power cable further comprises:
a first power cable insulator material selected from the group consisting of polyether ketone and polyether ketone ether ketone ketone; and
a second power cable insulator material selected from the group consisting of polyether ketone, polyether ether ketone, polyimide, and polyether ketone ether ketone ketone, wherein the second insulator material is different than the first insulator material.

23. The electrical submersible pumping system of claim 22, wherein the first power cable insulator material and second power cable insulator material are used to surround different areas of the power cable conductor.

24. The electrical submersible pumping system of claim 22, wherein the first power cable insulator material surrounds the power cable conductor and the second power cable insulator material surrounds the first power cable insulator material.

25. The electric submersible pumping system of claim 22, wherein the second insulator material surrounds the conductor and the first insulator material surrounds the second insulator material.

26. The electrical submersible pumping system of claim 22, further comprising an intermediate glass filled layer between the first power cable insulator material and second power cable insulator material.

27. The electric submersible pumping system of claim 22, wherein at least one of the first insulator material and second insulator materials includes a filler selected from the group consisting of glass fiber and talc.
